(19) United States
(12) Patent Application Publication
(10) Pub. No.: US 2011/0195298 A1
(43) Pub. Date: Aug. 11, 2011

(54) STACKED SECONDARY BATTERY

(75) Inventors: Takao Daidoji, Kanagawa (JP); Koichi Zama, Kanagawa (JP)

(73) Assignee: NEC ENERGY DEVICES, LTD., Kanagawa (JP)

(21) Appl. No.: 13/062,641

(22) PCT Filed: Sep. 7, 2009
(86) PCT No.: PCT/JP2009/004412

§ 371 Date: Apr. 25, 2011

(30) Foreign Application Priority Data
Sep. 8, 2008 (JP) 2008-229293

(51) Int. Cl. H01M 10/02; H01M 2/02; H01M 2/18; H01M 10/36

(52) U.S. Cl. 429/153

(57) ABSTRACT

A stacked secondary battery having desirable characteristics against overcharging is provided.

In the stacked secondary battery, either of a planar positive electrode or a planar negative electrode is contained in a pouch-shaped separator oriented such that the direction in which a positive lead terminal or a negative lead terminal is drawn out is aligned with a machine direction of the separator; a synthetic resin film is applied to the pouch-shaped separator across an edge of a joint area on both sides of the separator, the synthetic resin film having an adhesion strength higher than the stress caused by thermal contraction of the separator and having a softening point higher than that of the separator; and the positive electrode or the negative electrode that is contained in the pouch-shaped separator is stacked with a counter electrode that is not contained in the separator in an opposed manner to form a stacked battery element, which in turn is sealed in a film-like casing.

### TECHNICAL FIELD

The present invention relates to a stacked secondary battery consisting of a battery element obtained by stacking planar positive electrodes and negative electrodes, the battery element being sealed in a film-like outer casing. Either of positive electrodes or negative electrodes are contained in pouch-shaped separators and stacked with the respective counter electrodes.

### BACKGROUND ART

Lithium ion batteries and other large charge-discharge capacity batteries are widely used in various portable battery-powered devices, including cellular phones. Effective secondary batteries having a large charge-discharge capacity are also required in such applications as electric automobiles, electric bicycles, electric tools and electric energy storage.

These high power batteries use a stacked battery in which plate-shaped positive electrodes and plate-shaped negative electrodes are stacked together with separators disposed in between. The positive electrodes use an aluminum foil to serve as a current collector. The current collectors of the positive electrodes are coated with lithium-transition metal complex oxide particles and a conductivity-imparting agent such as carbon black. Likewise, the negative electrodes use a copper foil to serve as a current collector. The current collectors of the negative electrodes are coated with carbon particles such as graphite particles and a conductivity-imparting agent such as carbon black.

To make the plate-shaped positive electrodes and negative electrodes, the respective electrode active materials are applied to a band-shaped aluminum foil and a band-shaped copper foil serving as a current collector over a predetermined area thereof. The respective uncoated areas on which the active material layer is not deposited are integrally formed with the coated areas for connecting tabs to provide electrical connection.

To make stacked secondary batteries such as lithium ion batteries, the plate-shaped positive electrodes and negative electrodes are stacked together with the separators disposed in between to form a battery element, which in turn is sealed in a film-like outer casing.

Despite the desirable volume energy density and mass energy density, the stacked secondary batteries sealed in the film-like outer casings are not encased in rigid outer containers and may therefore affect surrounding environments when their battery elements expand upon overcharging. Thus, effective countermeasures are needed to cope with the problems associated with overcharging of the high capacity stacked secondary batteries.

The planar positive electrodes used in the stacked lithium ion batteries are contained in a pouch-shaped separator for stacking with the negative electrodes. Although the pouch-shaped separators can improve reliability of the batteries as compared to separator sheets that are arranged independently from one another, these pouch-shaped separators may deform when they are excessively heated and undergo thermal contraction or when they are exposed to high pressure gas generated by decomposition of an electrolyte solution upon overcharging under harsh conditions exceeding current test standards. This deformation can cause the pouches to rupture in their joint areas joined by, for example, a thermal fusion process. As a result, the positive electrodes may come into contact with the negative electrodes.

Certain non-aqueous electrolyte secondary batteries consist of a wound battery element encased in a metallic outer container. Separators used in these batteries may undergo thermal contraction and may come into electrical contact with the outer casing. To prevent the electrical contact between the thermally contracted separators and the outer casing in these batteries, it is proposed to use intervening insulator members that are a more effective insulator than the separators (See, for example, Patent Document 1). Similarly, non-aqueous electrolyte secondary batteries have been proposed in which an insulator member is adhered to a separator of a wound battery element (See, for example, Patent Document 2).

### PRIOR-ART DOCUMENT

### Patent Document

Patent Document 1: JP-A-2000-251866
Patent Document 2: JP-A-2006-196276

### SUMMARY OF INVENTION

### Technical Problem

Certain stacked secondary batteries consist of a stack of planar positive electrodes and planar negative electrodes with either of the positive electrodes or the negative electrodes are contained in pouch-shaped separators. It is an object of the present invention to provide such stacked secondary batteries in which battery runaway is prevented under test conditions that significantly exceed the performance of batteries currently required to counteract overcharging. Specifically, it is an object of the present invention to provide stacked secondary batteries in the form of lithium ion batteries in which battery runaway is prevented under a condition of 36V-1 C, which is significantly more extreme than the 10V-1 C condition specified by the IEC standards.

### Solution to Problem

The present invention is a stacked secondary battery in which either of a planar positive electrode or a planar negative electrode is contained in a pouch-shaped separator oriented such that the direction in which a positive lead terminal or a negative lead terminal is drawn out is aligned with a machine direction of the separator; a synthetic resin film is applied to the pouch-shaped separator across an edge of a joint area on both sides of the separator, the synthetic resin film having an adhesion strength higher than the stress caused by thermal contraction of the separator and having a softening point higher than that of the separator; and the positive electrode or the negative electrode that is contained in the pouch-shaped separator is stacked with a counter electrode that is not contained in the separator in an opposed manner to form a stacked battery element, which in turn is sealed in a film-like casing.

The present invention is the above-described stacked secondary battery in which a part of the synthetic resin film applied to the pouch-shaped separator across the edge of the joint area on both sides of the separator is included in a projection of the positive electrode or the negative electrode within the pouch-shaped separator projected in the direction of stacking.

Also, the present invention is the above-described stacked secondary battery in which the pouch-shaped separator and the negative electrode are stacked together while being positioned by the outer periphery of the pouch-shaped separator and two adjacent sides of the negative electrode other than the edge from which the electrode lead terminal is drawn out.

The present invention is the above-described stacked secondary battery in which a positioning area for positioning the positive electrode or the negative electrode is formed within the pouch-shaped separator.

### Advantageous Effect of the Invention

In the stacked secondary battery of the present invention, either of positive electrodes or negative electrodes are contained in pouch-shaped separators oriented such that the direction in which an electrode lead terminal is drawn out is aligned with the machine direction of the separator. A synthetic resin film is applied to the separator on both sides on the outside of the separator and across the edge aligned with the machine direction of the separator. The synthetic resin film has adhesion strength higher than the stress caused by the thermal contraction of the separator. The separators containing the positive electrodes or the negative electrodes are stacked with the planer counter electrodes to form a stacked battery element, which in turn is sealed in a film-like casing. This construction can prevent the pouch-shaped separator from rupturing in the joint area when a voltage significantly higher than intended is applied to cause overcharging. Such overcharging can cause gases to be produced to build up pressure or produce heat that leads to a stress caused by the thermal contraction of the separator, resulting in the rupture of the separator. As a result, the battery runaway that occurs when the separator is ruptured and the positive electrodes are brought into contact with the negative electrodes can be prevented.

### BRIEF DESCRIPTION OF DRAWINGS

FIG. 1 is a diagram illustrating one embodiment of a stacked secondary battery of the present invention. FIG. 1A is a perspective view of the stacked secondary battery. FIG. 1B is a cross-sectional view taken along line A-A in FIG. 1A. FIG. 1C is an enlarged view of a part of FIG. 1B corresponding to FIG. 1C.

FIG. 2 is a diagram illustrating steps in the production of the stacked secondary battery of the present invention. FIGS. 2A, 2B, 2C, 2E and 2F are diagrams illustrating respective steps. FIG. 2D is a cross-sectional view taken along line A-A′ in FIG. 2B.

FIG. 3 is a diagram illustrating another embodiment of the stacked secondary battery of the present invention. FIG. 3A is a perspective view of the stacked secondary battery. FIG. 3B is a cross-sectional view taken along line A-A in FIG. 3A. FIG. 3C is an enlarged view of a part of FIG. 3B corresponding to FIG. 3C.

### BEST MODE FOR CARRYING OUT THE INVENTION

A stacked secondary battery of the present invention will now be described with reference to a lithium ion battery. In this battery, positive electrodes contained in pouch-shaped separators are stacked with negative electrodes to form a battery element, which in turn is sealed in a film-like casing. When this battery is charged at a high voltage and at a high charging rate that are significantly higher than the 10V-1 C condition specified by the international safety standards for overcharging, pressure may build up as gases are produced by the decomposition of an electrolyte solution or a stress may result from the thermal contraction of the separators. As a result, the pouch-shaped separators may rupture in their joint areas before the fuse function of the separators is activated, causing the positive electrode near the ruptured area to come into direct contact with the negative electrode.

The present inventors have found that by preventing the pouch-shaped separators from rupturing in their joint areas before the fuse function of the separator is activated to block the permeation of ions across the separator, the effects that the stacked secondary battery may cause on the surrounding environment can be minimized when the battery is overcharged at a higher voltage and at higher rate than intended.

The present invention will now be described with reference to the drawings.

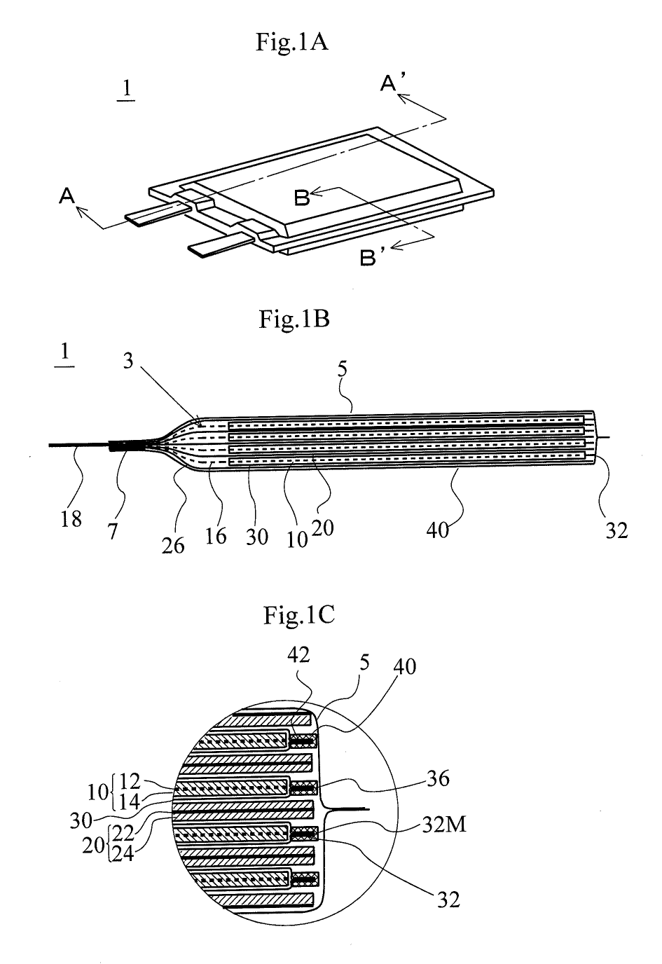

FIG. 1 is a diagram illustrating one embodiment of a stacked secondary battery of the present invention. FIG. 1A is a perspective view of the stacked secondary battery. FIG. 1B is a cross-sectional view taken along line A-A′ in FIG. 1A. FIG. 1C is an enlarged view of a part of FIG. 1B corresponding to FIG. 1C.

A stacked secondary battery 1 of the present invention described with reference to a lithium ion battery is composed of rectangular plate-shaped positive electrodes and rectangular plate-shaped negative electrodes.

The stacked secondary battery 1 includes a battery element 3 sealed in a film-like outer casing 5. The battery element 3 includes pouch-shaped separators 30 that contain the rectangular plate-shaped positive electrodes 10 and are stacked with the rectangular plate-shaped negative electrodes 20 with the pouch-shaped separators 30 arranged between the positive and the negative electrodes.

The positive electrode 10 has a positive electrode active material layer 14 deposited on a positive electrode collector 12 and has respective positive lead terminals 16 connected thereto. A set of the positive lead terminals 16 are joined together and connected to a positive electrode terminal 18, which in turn is drawn out to the outside through the sealed area 7. Likewise, the negative electrode 20 has a negative electrode active material layer 24 deposited on a negative electrode collector 22 and has respective negative lead terminals 26 connected thereto. A set of the negative lead terminals 26 are joined together and connected to a negative electrode terminal (not shown), which in turn is drawn out to the outside.

The pouch-shaped separator 30 has a joint area 32 formed thereon except for the edge on which the positive lead terminal 16 is arranged. The joint area 32 is formed by a thermal fusion process or other suitable processes. As illustrated in an enlarged view of FIG. 1C, a synthetic resin film 40 is adhered to the outer surface of the joint area 32 by the adhesive layer 42 and extends across the edge 36 of the pouch-shaped separator 30 along the width perpendicular to the direction in which the positive lead terminal is drawn out.

The synthetic resin film 40 can adhere to the separator with a greater adhesion strength than the stress caused by the thermal contraction of the separator. The synthetic resin film 40 may also be of high heat resistance so that the film does not soften below the softening temperature of the separator.

In general, original separator fabrics are produced by stretching a separator material, and forming pores with a predetermined porosity either simultaneously or in a separate step. Thus, the fibers in the fabric are oriented in the machine direction, or MD, during the production. In general, the fabrics are wound in the machine direction.

To make the pouch-shaped separators from an original separator fabric, separator fabrics are used that are wound in the machine direction and in which the length of the rectangular electrodes are aligned with the machine direction.

Thus, when the separators undergo thermal contraction, stress is generated in the direction transverse to the machine direction, or TD, causing the separator to contract in the TD direction. In contrast, less contraction stress is generated in the MD direction.

Accordingly, the characteristics of the pouch-shaped separator are not substantially affected even if the synthetic resin film is not applied to the separator in the joint area 32M at one end of the pouch-shaped separator in the MD direction.

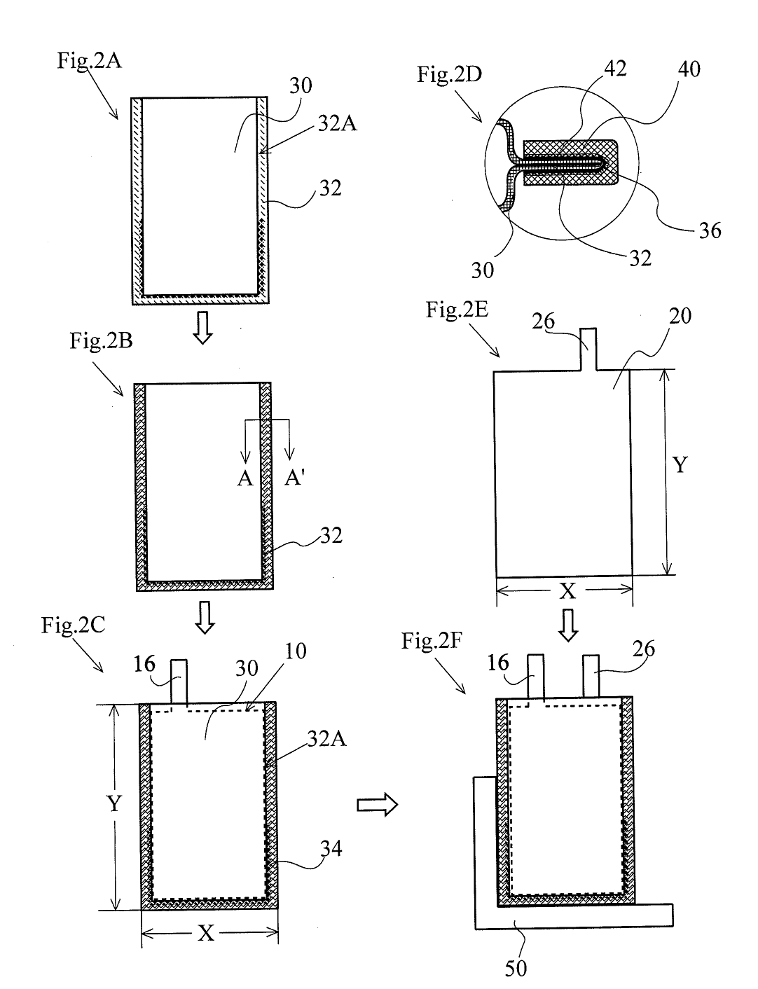

FIG. 2 is a diagram illustrating steps in the production of the stacked secondary battery of the present invention.

As shown in FIG. 2A, the pouch-shaped separator 30 is produced by cutting an original separator fabric to a predetermined size and joining three sides of the cut fabric other than the side to which the positive electrode is inserted, by a thermal fusion process or other suitable processes to form a joint area 32.

The original separator fabric has a machine direction, or MD, along which the fibers of the separator are oriented, and a transverse direction, or TD, perpendicular to the machine direction and is unwound from a roll of the original separator fabric in the machine direction and cut to a predetermined size. Subsequently, the cut separator is arranged by aligning the machine direction with the long side of the rectangular positive electrode and is then joined in the joint area 32 to form a pouch.

During joining of the separator to make a pouch-shaped separator, a positioning area 34 may also be formed for positioning the positive electrode at a distance from the outer periphery of the separator when the positive electrode is placed in the pouch-shaped separator.

Instead of forming the positioning area 34, a part 32A of the joint area 32 located inside the pouch-shaped separator 30 may be used as the positioning area.

As shown in FIG. 2B, a synthetic resin film 40 is then applied to the joint area 32 of the pouch-shaped separator across the edge 36 of the joint area 32 of the pouch-shaped separator.

FIG. 2D is an enlarged cross-sectional view taken along line A-A′ in FIG. 2B.

The synthetic resin film 40 is applied to both sides of the outer surface of the joint area 32 across the edge 36 of the joint area 32 of the pouch-shaped separator 30.

The synthetic resin film 40 may have a higher softening point than separators such as a polypropylene film and may not be deformed by the stress caused by heat contraction of the separator. Specific examples include films made of polystyrene, polyimide or other suitable materials. The adhesive layer 42 to be deposited on the synthetic resin film 40 may be an acryl-based adhesive or other adhesive layers that have desirable chemical resistance.

As shown in FIG. 2C, a positive electrode 10 is then placed in the pouch-shaped separator 30. The positive electrode 10 is positioned by the positioning area 34 provided within the pouch-shaped separator, or by the inner surface 32A of the joint area of the pouch-shaped separator 30 that replaces the positioning area. As a result, a pouch-shaped separator containing the positive electrode is obtained whose projection onto a surface parallel to the stack surface of the positive electrodes has a width X and a height Y. The positive electrode is arranged at a predetermined distance from the outer periphery of the pouch-shaped separator.

As shown in FIG. 2F, a predetermined number of the negative electrodes shown in FIG. 2E that each have the width X and the height Y and a predetermined number of the pouch-shaped separators shown in FIG. 2C that each contain the positive electrode are stacked together by aligning their two adjacent sides with a positioning jig 50. While the stack is held in place so that the positive electrodes and the negative electrodes will remain in alignment, the positive lead terminals 16 of the respective positive electrodes are connected together, as are the negative lead terminals 26 of the respective negative electrodes.

Subsequently, positive terminals are connected to the respective positive lead terminals and negative terminals are connected to the respective negative lead terminals to form a battery element, which in turn is sealed in a film-like outer casing to make a stacked secondary battery.

While the stacked secondary battery has been described above with reference to a lithium ion battery in which the negative electrodes are larger than the opposing positive electrodes in area, the positive electrodes may be larger than the negative electrodes in area, in which case the battery can be produced in a similar manner by placing the negative electrodes in the pouch-shaped separators.

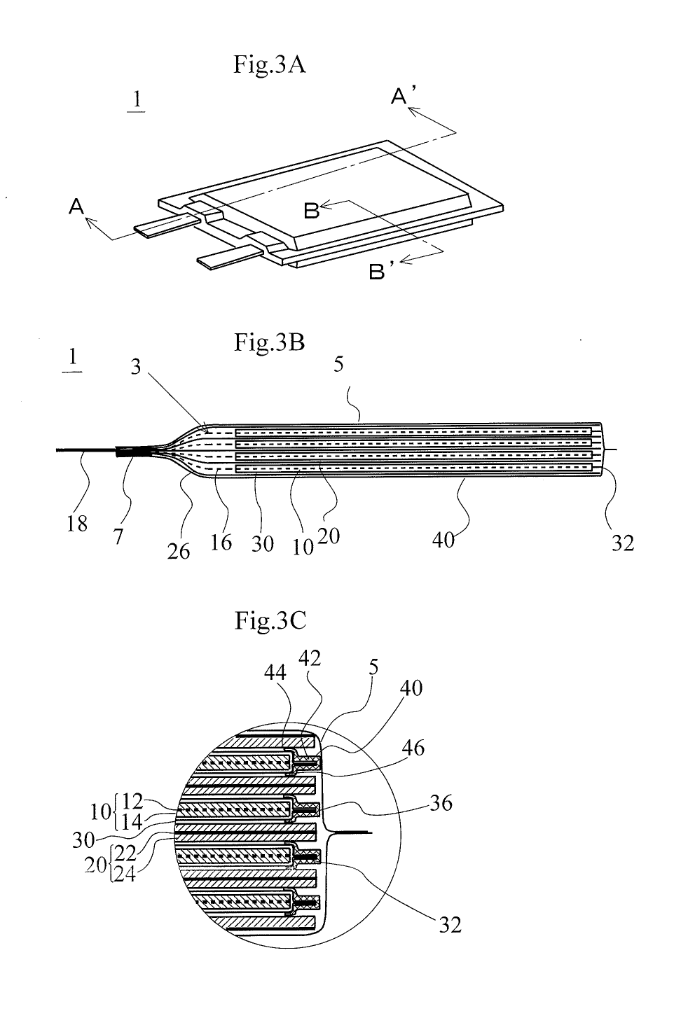

FIG. 3 is a diagram illustrating another embodiment of the present invention. FIG. 3A is a perspective view of a stacked secondary battery. FIG. 3B is a cross-sectional view taken along line A-A′ in FIG. 3A. FIG. 3C is an enlarged view of a part of FIG. 3B corresponding to FIG. 3C.

The stacked secondary battery shown in FIGS. 3A, 3B and 3C have a similar construction to the stacked secondary battery described with reference to FIG. 1, except for the position of the synthetic resin film 40 applied to the joint area 32 along the width perpendicular to the direction in which the positive lead terminal is drawn out.

Specifically, the stacked secondary battery 1 includes a battery element 3 sealed in a film-like outer casing 5. The battery element 3 includes pouch-shaped separators 30 that contain rectangular plate-shaped positive electrodes 10 and are stacked with rectangular plate-shaped negative electrodes 20 with the pouch-shaped separators 30 arranged between the positive and the negative electrodes.

The positive electrode 10 has a positive electrode active material layer 14 deposited on a positive electrode collector 12 and has respective positive lead terminals 16 connected thereto. A set of the positive lead terminals 16 are joined together and connected to a positive electrode terminal 18, which in turn is drawn out to the outside through the sealed area 7. Likewise, the negative electrode 20 has a negative electrode active material layer 24 deposited on a negative electrode collector 22 and has respective negative lead terminals 26 connected thereto. A set of the negative lead terminals 26 are joined together and connected to a negative electrode terminal (not shown), which in turn is drawn out to the outside.

The pouch-shaped separator 30 has a joint area 32 formed thereon except for the edge on which the positive lead terminal 16 is arranged. The joint area 32 is formed by a thermal fusion process or other suitable processes. As illustrated in an enlarged view of FIG. 3C, a synthetic resin film 40 is adhered to the outer surface of the joint area 32 by the adhesive layer 42 with an adhesion strength greater than the stress caused by thermal contraction of the separator and extends across the edge 36 of the pouch-shaped separator 30 along the width perpendicular to the direction in which the positive lead terminal is drawn out.

Since ends 44, 46 of the adhered synthetic resin film 40 are joined to the pouch-shaped separator in the projection of the positive electrode projected in the direction of stacking, the separator is reinforced by the synthetic resin film in the projection of the ends of the positive electrode in the direction of stacking.

As a result, the separator is prevented from tearing or puncturing when the separator undergoes thermal contraction and is pulled in the direction parallel to the positive electrode to come into contact with the edges of the positive electrode. This further improves the effect of the synthetic resin film adhesion.

### EXAMPLES

### Example 1

A slurry composed of 63 parts by mass of a lithium-manganese complex oxide, 4.2 parts by mass of acetylene black having a number-average particle size of 7 μm, 2.8 parts by mass of polyvinylidene fluoride and 50 parts by mass of N-methyl-2-pyrrolidone was prepared.

The slurry was applied to a 20 micrometer-thick, 150 mm-wide aluminum foil as a current collector across the width of the foil and intermittently along the length of the foil in lengths of 130 mm with uncoated lengths of 20 mm. The coated collector was dried and pressed to form a 180 micrometer-thick layer of the positive electrode active material.

A 13 mm-wide, 17 mm-long electrode lead terminal is formed in each uncoated area to make positive electrodes coated in a 65 mm-wide, 125 mm-long area thereof.

Each positive electrode was covered with a 25 micrometer-thick polypropylene separator and was joined to the separator over a 1.5 mm end portion of the positive electrode by thermal fusion.

Subsequently, a 30 micrometer-thick polypropylene tape having an acryl-based adhesive layer was applied to the separator across the end in the machine direction of the separator over a 1 mm area from the end of the projection of the positive electrode onto the separator projected in the direction of stacking.

14 positive electrodes covered by the pouch-shaped separators and 15 negative electrodes were then stacked together and positive lead terminals and negative terminals were connected. Each stack was placed in a bag formed of a film-like casing. As an electrolyte solution, a mixed solvent of ethylene carbonate and diethyl carbonate containing 1M LiPF₆ was injected into the bag. The bags were sealed to make a total of 10 lithium ion batteries.

The 10 lithium ion batteries so obtained were overcharged at a 1 C current to 35V. None of the batteries produced smoke.

### Comparative Example 1

10 lithium ion batteries were produced in the same manner as in Example 1, except that the synthetic resin tape with the adhesive layer was not applied across the joint area of the separator. In the same overcharging test, 4 of the lithium ion batteries produced smoke when charged at a 1 C current to 25V.

### INDUSTRIAL APPLICABILITY

A stacked secondary battery provided by the present invention includes planar positive electrodes and planar negative electrodes, either of which are contained in pouch-shaped separators oriented such that the direction in which positive lead terminals are drawn out is aligned with the machine direction of the separator. A synthetic resin film is applied to the pouch-shaped separator in the joint area on both sides on the outside of the separator and across the edge extending in the machine direction of the separator. The synthetic resin film has adhesion strength higher than the stress caused by the thermal contraction of the separator and has a softening point higher than the softening temperature of the separator. The separators containing the positive electrodes are stacked with the planar negative electrodes to form a stacked battery element, which in turn is sealed in a film-like casing. The pouch-shaped separator having such a construction can provide highly safe stacked secondary batteries in which battery runaway is prevented even when the batteries are charged at a higher voltage and at a higher charging rate than intended.

### REFERENCE SIGNS LIST

1: Stacked secondary battery
3: Battery element
5: Film-like outer casing
7: Sealed area
10: Positive electrode
12: Positive electrode collector
14: Positive electrode active material layer
16: Positive lead terminal
18: Positive electrode terminal
20: Negative electrode
22: Negative electrode collector
24: Negative electrode active material layer
26: Negative lead terminal
30: Pouch-shaped separator
32: Joint area
32A: Inner surface of joint area
32M: Joint area at 1 W end
34: Positioning area
36: Edge of pouch-shaped separator
40: Synthetic resin film
42: Adhesive layer
44, 46: End
50: Positioning jig

1. A stacked secondary battery, characterized in that either of a planar positive electrode or a planar negative electrode is contained in a pouch-shaped separator oriented such that the direction in which a positive lead terminal or a negative lead terminal is drawn out is aligned with a machine direction of the separator; a synthetic resin film is applied to the pouch-shaped separator across an edge of a joint area on both sides of the separator, the synthetic resin film having an adhesion strength higher than the stress caused by thermal contraction of the separator and having a softening point higher than that of the separator; and the positive electrode or the negative electrode that is contained in the pouch-shaped separator is stacked with a counter electrode that is not contained in the separator in an opposed manner to form a stacked battery element, which in turn is sealed in a film-like casing.

2. The stacked secondary battery according to claim 1, characterized in that a part of the synthetic resin film applied to the pouch-shaped separator across the edge of the joint area on both sides of the separator is included in a projection of the positive electrode or the negative electrode within the pouch-shaped separator projected in the direction of stacking.

3. The stacked secondary battery according to claim 1, characterized in that the pouch-like separator and the negative electrode are stacked together while being positioned by the outer periphery of the pouch-shaped separator and two adjacent sides of the negative electrode other than the edge from which the electrode lead terminal is drawn out.

4. The stacked secondary battery according to claim 1, characterized in that, a positioning area for positioning the positive electrode or the negative electrode is formed within the pouch-like separator.

5. The stacked secondary battery according to claim 2, characterized in that the pouch-like separator and the negative electrode are stacked together while being positioned by the outer periphery of the pouch-shaped separator and two adjacent sides of the negative electrode other than the edge from which the electrode lead terminal is drawn out.

6. The stacked secondary battery according to claim 2, characterized in that, a positioning area for positioning the positive electrode or the negative electrode is formed within the pouch-like separator.

7. The stacked secondary battery according to claim 3, characterized in that, a positioning area for positioning the positive electrode or the negative electrode is formed within the pouch-like separator.
